(19) United States
(12) Patent Application Publication
(10) Pub. No.: US 2026/0160703 A1
(43) Pub. Date: Jun. 11, 2026

(54) SYSTEM AND METHOD FOR AUTOMATICALLY VALIDATING THE RESPONSE COMPLIANCE OF A PENETRANT TESTING LINE

(71) Applicant: SAFRAN HELICOPTER ENGINES, Bordes (FR)

(72) Inventor: Patrick Lucien Francois Briffa, Moissy-Cramayel (FR)

(21) Appl. No.: 18/708,851

(22) PCT Filed: Nov. 16, 2022
(86) PCT No.: PCT/EP2022/082156

§ 371 Date: May 9, 2024

(30) Foreign Application Priority Data
Nov. 22, 2021 (FR) FR2112317

(51) Int. Cl. G01N 21/91; G01N 21/88

(52) U.S. Cl. CPC G01N 21/91; G01N 21/8806

(57) ABSTRACT

A system for automatically validating the response compliance of a penetrant testing line by analysis of a reference test specimen with cracks undergoing dye penetrant testing and coming from said penetrant testing line, includes a casing surrounding all the elements of the system, a positioning base for the reference test specimen undergoing dye penetrant testing, at least two ultraviolet lighting devices positioned on either side of the positioning base so as to be able to illuminate it with ultraviolet light, an electronic board, a motorised linear guide controlled by the electronic board and suitable for being able to move the positioning base and hold said positioning base in position in the casing, and a monochrome camera having a lens directed towards the positioning base.

### TECHNICAL FIELD

The present invention relates to non-destructive methods for checking and sanctioning the compliance of penetrant testing lines.

Penetrant testing aims to non-destructively detect cracks on the surface of a part by covering the surface thereof with a penetrating liquid, coloured or fluorescent, and then observing the resurgence of the liquid from the cracks.

The present invention aims to form a system and its method for validating penetrant testing lines non-destructively and particularly repeatably, wherein the variability of human analyses is guarded against and which affords traceability of the successive responses of the penetrant testing lines.

### PRIOR ART

Methods are known for validating penetrant testing lines consisting in passing a reference test specimen (“PSM-5P” or “PSM-5P-TAM” shims for example) through the penetrant testing line and deducing therefrom a sanction according to the response thereof.

The current methods leave the responsibility for the sanction to an operator, who has the task of visually and qualitatively comparing the reference test shim coming from the penetrant testing line with a reference image, which may possibly vary according to his interpretation.

An approach aimed at controlling this method leads to a periodic check on the size of the cracks visible in penetrant testing that must not drift.

This drift may be fixed for example at a threshold of thirty percent with respect to the values observed on a reference test shim.

This validation step enables series production by penetrant testing.

In the current methods, the human factor therefore constitutes a potential variability factor, whereas the challenge of validating the penetrant testing line must be systematically respected to ensure conformity of the process and therefore the quality of the sanctions applied to the parts inspected by this means. This approach is crucial for series production.

In addition, repeatability and precision of assessment by the operator may vary since they are based on a qualitative analysis made by the eye of the operator.

Visual assessment moreover does not make it possible to archive all the data that allowed the sanction that would allow traceability of the benchmarking, for example recording data such as numerical information; the human eye does not allow it.

### DESCRIPTION OF THE INVENTION

The aim of the invention is to overcome at least some of aforementioned drawbacks and to propose a system for validating the response of a penetrant testing line capable of combining advantages of repeatability, stability and reliability for implementation thereof, while allowing traceability of the establishment of the section.

In light of above, the object of the invention is a system for automatically validating the response compliance of a penetrant testing line by the numerical analysis of a reference test specimen with crackes undergoing dye penetrant testing coming from said penetrant testing line, said system including a casing surrounding all the elements of the system, a positioning base for the reference test specimen undergoing dye penetrant testing, at least two ultraviolet lighting devices positioned on either side of the positioning base so as to be able to illuminate it with ultraviolet light, an electronic board, a motorised linear guide controlled by the electronic board and suitable for being able to move the positioning base and hold said base in position in the casing, and a monochrome camera having a lens directed towards the positioning base.

Preferably, said two ultraviolet lighting devices are inclined with respect to the vertical by an angle of between fifty-four and sixty-six degrees.

For example, the camera is at a distance from the positioning base of less than twenty centimetres and the camera has a lens of seventy-five millimetres coupled with an optical extension ring, adapted to provide an optical acquisition precision of less than ten micrometres.

Advantageously, the casing is provided with a door and a door-closure sensor coupled to the electronic card.

According to one embodiment, each lighting device includes a light-emitting diode.

Another object of the invention is a validation method for implementing a validation system as defined above, the method including the following steps:
placing on the positioning base a penetrant-testing reference test specimen including cracks and coming from said penetrant testing line,
targeting the camera in a focused manner on the cracks by actuating the motorised linear guide,
illuminating the cracks,
digitally acquiring an image of the cracks by means of the camera,
recording said image,
measuring the main dimensions of each crack,
dimensionally comparing the measurements with reference values,
sanctioning the response.

Advantageously, the duration of illumination of the cracks is substantially equal to the duration of acquisition of the image of the cracks; this making it possible to avoid drifts due to heating of the lighting devices.

The method can furthermore provide for a prior step in which the system is the subject of a reference standardisation by monitoring and calibration using two reference test patterns of different types, one of which is a test pattern with countersinks adapted to standardise the positioning provided by the positioning base and the precision of the measurements, and the other is a test pattern of the USAF1951© type used for testing intensity, dimension and surface measurements.

Preferably, a prior step is provided for, in which the system is the subject of reference standardisation using a referencing implemented on the basis of an initial response of the penetrant testing line.

The invention also relates to a method having a final step of archiving the image, the measurements and the sanction.

### BRIEF DESCRIPTION OF THE DRAWINGS

The invention will be better understood from the detailed study of an embodiment taken by way of non-limitative example and illustrated by accompanying drawings, on which:

FIG. 1 shows a system for validating a penetrant testing line according to the invention, in a perspective view.

FIG. 2 shows the test pattern with countersinks in front view.

FIG. 3 shows a crack on the test pattern with countersinks in front view.

FIG. 4 shows the steps of the method for validating a penetrant testing line.

### DETAILED DESCRIPTION

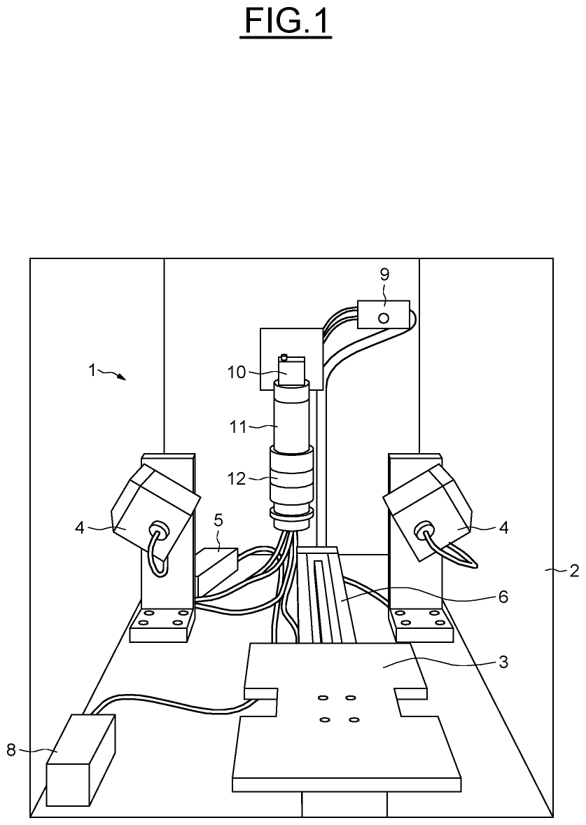

FIG. 1 illustrates the system 1 of the invention, which allows automatic validation of the response compliance of a penetrant testing line by analysing a reference test specimen undergoing dye penetrant testing coming from said penetrant testing line. The system 1 includes a casing 2, a positioning base 3 for the reference test specimen undergoing dye penetrant testing 13, at least two lighting devices 4, an electronic board located in a computer station, a motorised linear guide 6 controlled by the electronic board and suitable for being able to move the positioning base 3 and hold said base in position in the casing 2, and a monochrome camera 10 having a lens directed towards the positioning base 3.

An electrical supply 5 electrically supplies the components, in particular the lighting device 4, the guide 6 and the electronic board.

A disconnecting switch 9 can be provided for easily cutting off the electrical supply and stopping the method.

The casing 2 surrounds all the elements of the system 1 to be able to put them in darkness in order to protect the observation from any parasitic illuminations.

Advantageously, the casing 2 is provided with a door so as to be able to open it and close it before and after each implementation of the method described below.

The casing 2 can be provided with a door-closure sensor 8 coupled to the electronic board to enable or not the implementation of the method in the event of a closure fault with the door.

The electronic board can be coupled to a computer for image processing, displays and archiving the images of views and responses.

The two lighting devices 4 are positioned on either side of the positioning base 3 and overhanging so as to be able to illuminate it by downward lighting, which provides a localised, orientable and inclinable flow, with homogeneity on either side of the positioning base 3.

They illuminate in ultraviolet light, more particularly with an ultraviolet spectrum centred on the three hundred and sixty-five nanometre wavelength for optimum response of the penetrant used for penetrant testing.

Each lighting device 4 can include a light-emitting diode, which makes the lighting operational instantaneously, avoiding heating time and giving a stable light flow, i.e. one the power of which scarcely varies over time.

Preferably, the two ultraviolet lighting devices 4 are inclined with respect to the vertical by an angle of between fifty-four and sixty-six degrees.

This inclination of the spotlights defines the light incidence angle on the positioning base 3 that gives the highest ratio between the signal and the noise in the inclination range tested between thirty and seventy degrees.

It is necessary to have an angle of inclination greater than forty-five degrees.

The best positioning is obtained with an angle of inclination of around sixty degrees.

The camera 10 is preferentially at a distance from the positioning base 3 of less than twenty centimetres and the camera 10 has a lens 11 of seventy-five millimetres coupled with an optical extension ring, adapted to provide an optical acquisition precision of less than ten micrometres.

A bandpass filter 12 can be provided for further increasing this precision of acquisition.

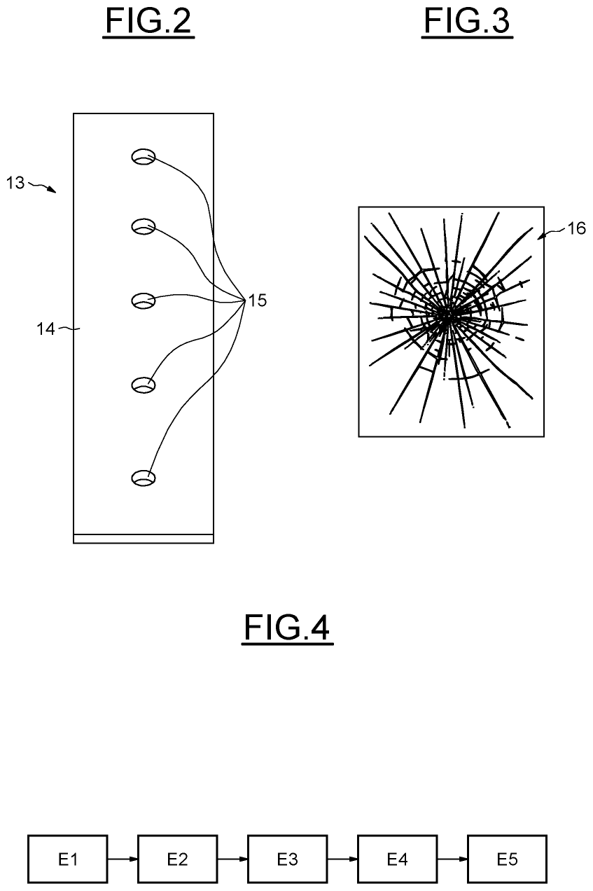

As illustrated by FIG. 2, the penetrant-testing reference test specimen is for example covered with a test pattern 13 with countersinks that includes a body 14 having standard and/or standardised dimensions, and five piercings 15 enabling the method to target five critical zones of the shim containing indications that are decisive for sanctioning the penetrant testing line.

The system 1 will illuminate all the zones, as illustrated by FIG. 2, and then autonomously analyse, measure and sanction these five zones of the reference test specimen shim, for example with advancement zone by zone.

As illustrated by FIG. 2, the penetrant-testing reference test specimen is for example a block that includes a body 14 having standard and/or standardised dimensions, and the method targets five critical zones of the shim containing indications that are decisive for sanctioning the penetrant testing line.

The system 1 eliminates all the zones, as illustrated by FIG. 2, and then autonomously analyses, measures and sanctions these five zones 15 of the reference test specimen shim, for example with advancement zone by zone.

The shim includes for example cracks 16 such as those illustrated by FIG. 3, constituting star-shaped indications for the system 1.

The indications 16 have for example diameters decreasing from top to bottom, with the largest dimension being able to be as much as 6.3 millimetres, and on average five millimetres in diameter for all the star-shaped cracks 16 before a positioning margin is added to this diameter.

Various reference test specimen shims can be used with different dimensions for the indications 16.

They are therefore unique and referencing must be made each time a shim is changed.

For the verification programs to be able to give a sanction after inspection, it is also necessary to link them to requirements, which are dependent on the characteristics of the initial reference test specimen shim, the performance of the penetrant testing line on the day of calibration, and assessment of the level of penetrant testing after analysis of the penetrant-tested shim.

The implementation method illustrated by FIG. 4 makes these steps particularly repeatable compared with the known methods, by virtue of the following steps:
a first step E1 of placing on the positioning base 3 a penetrant-testing reference test specimen including cracks 16 and coming from said penetrant testing line,
a step E2 of targeting the camera 10 in a focused manner on the cracks 16 by actuating the motorised linear guide 6,
a step E3 of illuminating the cracks 16,
a step E4 of digitally acquiring an image of the cracks 16 by means of the camera 10,
by means of the electronic board, a step E5 consisting in:
recording said image,
measuring the main dimensions of each crack 16,
dimensionally comparing the measurements with reference values, and
sanctioning the response is implemented.

The guide 6 is coupled to a protocol for calibrating the positioning of the positioning base 3 so as to ensure correct mechanical positioning of the PSM-5P shim in the system 1.

This calibration protocol joins the known traditional protocols particular to industrial machines with mechanical movement, with positioning precisions sought corresponding to the regulatory requirements laid down.

Advantageously, the duration of illumination of the cracks 16 in step E3 is substantially equal to the duration of acquisition of the image of the cracks 16.

A slight heating of the lighting systems 4 has been noted, even if they include a light-emitting diode that minimises the heat emitted.

This heat shifts the frequency peak of the ultraviolet emission spectrum by a few nanometres over time, following a logarithmic trend.

It is important to note that this phenomenon remains imperceptible to the eye and is difficult to detect unless a sufficiently sensitive device is used such as an imaging cell or a suitable sensor.

Consequently, because of this phenomenon, the fluorescence of the penetrant, sensitive to a wavelength centred at three hundred and sixty-five nanometres, becomes less intense despite the constant power of the lighting.

To overcome this effect, the lighting must be activated in a step E3 over a very short period of the “flash” type synchronised solely on the duration of acquisition of the image, which makes it possible to avoid the heating of the light-emitting diode emitter and to keep constant the wavelength at which the maximum energy value is emitted, thus giving an optimum and stable signal.

At step E4, the image acquisition is optimised by virtue of a two-dimensional matrix analysis in which only the shim installed on the positioning base 3 is observed in length and in width.

Acquisition in monochrome is done with a single colour observed by a grey-level analysis, which improves the precision of the observations.

The zones 15 are of the order of ten millimetres by ten millimetres around each star 16 of the block, which requires a matrix of two thousand pixels by two thousand pixels.

The distance between the camera and the block is preferentially less than twenty centimetres.

The acquisition precision is less than ten micrometres to correctly quantify and sanction the fifth indication 16, namely the smallest, since the maximum diametral dimension thereof can be as little as four hundred micrometres, even if on average it is generally approximately one millimetre in diameter.

To have a precision of ten micrometres or better, it is advantageous to sample over two pixels at a minimum, which gives a resolution of five micrometres per pixel.

Sampling is optimum over four pixels, which gives a resolution of two and a half micrometres per pixel.

In regular use of the equipment, the purpose of the system 1 is to automatically confirm the sanction corresponding to a good response level of the penetrant testing line by comparing analysis of a PSM-5P block passed over the line with the one serving as an initial reference.

This initial reference was obtained with the same PSM-5P block the response of which was recorded during the initial validation of the line for commissioning thereof on the basis of a penetrant testing response judged to be satisfactory by the person responsible for using the equipment.

Preferably, a prior step is implemented, in which the system 1 is the subject of reference standardisation using a referencing implemented on the basis of an initial response of the penetrant testing line.

The method for use seeing the system 1 can furthermore provide for an upstream step in which the system 1 is the subject of a reference standardisation by monitoring and calibration using two reference test patterns of different types.

One of the two reference test patterns is a test pattern 13 with countersinks adapted to standardise the positioning provided by the positioning base 3 and the precision of the measurements.

This test pattern 13 with countersinks makes it possible to check the PSM-5P block in the system 1 and the correct standardisation of the measurement of the diameters of the circular indications 16 by means of an algorithm provided in the electronic board and under ultraviolet lighting.

The checks by means of the test pattern 13 with countersinks therefore make it possible to ensure absence of any drift in the mechanics and kinematics of the system 1, but also affords an exact measurement of the stars 16 revealed in response to the penetrant testing, since the test pattern 13 with countersinks allows a suitable quantification of the star indications on the PSM-5P block whatever their geometry and size, their signature varying according to the rather round armless shape for the smallest star 16 and highly prominent arms for the first star, with a scale factor close to twenty between these two stars.

The other one of the two reference test patterns is a test pattern of the USAF1951© type used for testing intensity, dimension and surface measurements.

Using this standard test pattern as a resolution target make it possible to calculate intensity (signal/noise ratio) and to evaluate the number of pixels, and checking makes it possible to ensure stability of the values calculated.

By virtue of the two test patterns, a system 1 is thus obtained that makes it possible to avoid any intrinsic drifts in the system 1, and this by virtue furthermore of a monitoring of the mechanical position of the blocks, monitoring of the optical imaging means, and monitoring of algorithm for image processing and editing of automatic sanction provided in the electronic board.

The general technical standard specifying the penetrant testing method tolerates thirty percent annual variability on the measurements of the values of the diameters of the indications observed on a block, the system 1 making it possible to automatically make this measurement daily.

The system 1 has an intrinsic maximum variability of the order of two percent, i.e. of the order of uncertainty of measurement, which is satisfactory for declaring it capable.

Sanction of the response of the penetrant testing line can be based solely on the measurements of diameter of the stars 16 of the block, after thresholding on the grey levels, without necessarily having to take account of the distribution histogram of the grey levels or the number of pixels for sanctioning compliance of the response of the penetrant testing line, and the histogram of the grey levels and the number of pixels can however continue to the monitored by way of indication in order to make it possible to check and control with more precision and reactivity with regard to any drifts of the penetrant testing line over time.

The method can include a final step of archiving the image, the measurements and the sanction.

Unlike the known methods, the system 1 therefore allows recording of the images of the five zones as well as the inspection values, which affords total and reliable traceability thereof, since it is digital.

1. A system for automatically validating a response compliance of a penetrant testing line by numerical analysis of a reference test specimen with cracks undergoing dye penetrant testing coming from said penetrant testing line, said system comprising:
said reference test specimen with cracks undergoing dye penetrant testing coming from said penetrant testing line;
a casing surrounding all the elements of the system;
a positioning base for the reference test specimen undergoing dye penetrant testing;
at least two ultraviolet lighting devices positioned on either side of the positioning base so as to be able to illuminate it with ultraviolet light;
an electronic board;
a motorised linear guide controlled by the electronic board and suitable for being able to move the positioning base and hold said positioning base in position in the casing; and
a monochrome camera having a lens directed towards the positioning base, wherein each lighting device includes a light-emitting diode.

2. The system according to claim 1, wherein said two ultraviolet lighting devices are inclined with respect to a vertical by an angle of between fifty-four and sixty-six degrees.

3. The system according to claim 1, wherein the camera is preferentially at a distance from the positioning base of less than twenty centimetres and the camera has a lens of sixty-five millimetres coupled with an optical extension ring, adapted to provide an optical acquisition precision of less than ten micrometres.

4. The system according to claim 1, wherein the casing is provided with a door and a door-closure sensor coupled to an electronic card.

5. A method for validating a response compliance of a penetrant testing line for implementing a system according to claim 1, the method comprising:
placing (E1) on the positioning base a penetrant-testing reference test specimen including cracks and coming from said penetrant testing line;
targeting (E2) the camera in a focused manner on the cracks by actuating the motorised linear guide;
illuminating (E3) the cracks;
digitally acquiring (E4) an image of the cracks by means of the camera;
recording said image;
measuring the main dimensions of each crack;
dimensionally comparing the measurements with reference values; and
sanctioning the response.

6. The method according to claim 5, wherein a duration of illumination of the cracks is substantially equal to a duration of acquisition of the image of the cracks.

7. The method according to claim 5, further comprising a prior step in which the system is a subject of a reference standardisation by monitoring and calibration using two reference test patterns of different types, one of which is a test pattern with countersinks adapted to standardise the positioning provided by the positioning base and precision of the measurements, and the other is a test pattern of the USAF1951© type used for testing intensity, dimension and surface measurements.

8. The method according to claim 5, further comprising a prior step in which the system is a subject of reference standardisation using a referencing implemented on the basis of an initial response of the penetrant testing line.

9. The method according to claim 5, further comprising a final step of archiving the image, the measurements and the sanction.
